(19) United States
(12) Patent Application Publication
(10) Pub. No.: US 2026/0121822 A1
(43) Pub. Date: Apr. 30, 2026

(54) DEVICE FOR PERFORMING DEVICE-TO-DEVICE COMMUNICATION BASED ON HIGH-SPEED SERIAL INTERFACE AND OPERATING METHOD THEREOF

(71) Applicant: Panmnesia Inc., Daejeon (KR)

(72) Inventors: Dong Hyun GOUK, Daejeon (KR); Eo Jin Ryu, Daejeon (KR)

(73) Assignee: Panmnesia Inc., Daejeon (KR)

(21) Appl. No.: 19/371,170

(22) Filed: Oct. 28, 2025

(30) Foreign Application Priority Data
Oct. 31, 2024 (KR) 10-2024-0152482

(51) Int. Cl. H04L 7/00

(52) U.S. Cl. CPC H04L 7/0079; H04L 7/0075

(57) ABSTRACT

A first device communicating with a second device through a high-speed serial interface includes an interface controller configured to recover data received via the high-speed serial interface and a component configured to perform a selected operation based on the recovered data, the interface controller including a recovered clock domain circuit configured to operate based on a recovered clock corresponding to a data transmission rate of the high-speed serial interface and a local clock domain circuit configured to operate based on a local clock having a frequency adaptively controlled based on a frequency of the recovered clock.

### CROSS-REFERENCE TO RELATED APPLICATION

This application is based on and claims priority under 35 U.S.C. §119 to Korean Patent Application No. 10-2024-0152482, filed on October 31, 2024, in the Korean Intellectual Property Office, the disclosure of which is incorporated by reference herein in its entirety.

### BACKGROUND

### 1. Field

The disclosure relates to a device for performing device-to-device communication based on a high-speed serial interface.

### 2. Description of the Related Art

Recently, technologies for high-speed serial interfaces have been proposed for high-speed data communication between devices. Among such technologies for high-speed serial interfaces, peripheral component interconnect express (PCIe) and compute express link (CXL) technologies have been actively researched.

A device for performing communication using a high-speed serial interface may include a recovered clock domain circuit that operates based on a recovered clock derived from device-to-device communication and a local clock domain circuit that operates based on a local clock within the device. The recovered clock domain circuit may include an elastic buffer used to align symbols received per lane to the local clock. Specifically, symbols are input to the elastic buffer based on the divided recovered clock, and symbols stored based on the local clock may be output based on the local clock.

The elastic buffer may operate by adding specific symbols to the elastic buffer when the frequency of the local clock is higher than the frequency of the recovered clock, or by deleting specific symbols stored in the elastic buffer when the frequency of the local clock is lower than the frequency of the recovered clock.

However, the operating method of the elastic buffer described above may cause high latency, which may impose a load on high-speed data communication, and therefore improvements are required.

### SUMMARY

Provided are a device for effectively operating an elastic buffer by adaptively controlling a frequency of a local block based on a frequency of a recovered block and an operating method of the device.

Additional aspects will be set forth in part in the description which follows and, in part, will be apparent from the description, or may be learned by practice of the presented embodiments of the disclosure.

According to an aspect of the disclosure, a first device communicating with a second device through a high-speed serial interface includes an interface controller configured to recover data received via the high-speed serial interface and a component configured to perform a selected operation based on the recovered data, in which the interface controller includes a recovered clock domain circuit configured to operate based on a recovered clock corresponding to a data transmission rate of the high-speed serial interface and a local clock domain circuit configured to operate based on a local clock having a frequency adaptively controlled based on a frequency of the recovered clock.

The high-speed serial interface according to an embodiment may be implemented as any one of a compute express link (CXL) interface, a peripheral component interconnect express (PCIe) interface, a serial AT attachment (SATA) interface, a universal serial bus (USB) interface, a display port interface, and an Ethernet interface.

The recovered clock domain circuit according to an embodiment may include a deserialization register configured to deserialize the received data based on the recovered clock and an elastic buffer configured to store the deserialized data from the deserialization register based on a divided recovered clock, and to output the stored data to the local clock domain circuit based on the local clock, wherein a frequency of the local clock may be higher than a frequency of the divided recovered clock.

The elastic buffer according to an embodiment may include one slot for storing deserialized data received at a time from the deserialization register.

The local clock domain circuit according to an embodiment may include a decoder configured to decode data output from the elastic buffer based on the local clock.

The recovered clock domain circuit and the local clock domain circuit according to an embodiment may correspond to a physical layer.

The interface controller according to an embodiment may be further configured to, in an initialization period, signal with the second device via the high-speed serial interface to determine the data transmission rate of the high-speed serial interface, and set a frequency of the local clock based on the determined data transmission rate.

The interface controller according to an embodiment may be further configured to, in a communication period, signal with the second device via the high-speed serial interface to change the data transmission rate of the high-speed serial interface, and change a frequency of the local clock based on the changed data transmission rate.

The interface controller according to an embodiment may be further configured to, in the communication period, detect a change in the frequency of the recovered clock, and adjust the frequency of the local clock based on a detection result.

The interface controller according to an embodiment may be further configured to, in the communication period, detect at least one parameter associated with a factor for a change in the frequency of the recovered clock, and adjust the frequency of the local clock based on a detection result.

The at least one parameter according to an embodiment may include at least one of a first parameter associated with a transmission media delay of the high-speed serial interface, a second parameter associated with crosstalk between lanes of the high-speed serial interface, a third parameter associated with electromagnetic interference within the first device, and a fourth parameter associated with a temperature of the first device.

The component according to an embodiment may be implemented as a processor when the first device is implemented as a host device, and may be implemented as a memory device when the first device is implemented as a storage device.

According to another aspect of the disclosure, a first device communicating with a second device through a high-speed serial interface includes an interface controller configured to recover data received via the high-speed serial interface and a component configured to perform a selected operation based on the recovered data, in which the interface controller includes a deserialization register configured to deserialize the received data based on a recovered clock corresponding to a data transmission rate of the high-speed serial interface, an elastic buffer configured to store deserialized data from the deserialization register based on a divided recovered clock, and to output the stored data based on a local clock, a decoder configured to decode data output from the elastic buffer based on the local clock, and a control circuit configured to control the local clock such that a frequency of the local clock is higher than a frequency of the divided recovered clock.

The interface controller according to an embodiment may include a recovered clock phased locked loop (PLL) configured to generate the recovered clock and a local clock PLL configured to generate the local clock, wherein the control circuit may be further configured to provide a control signal to the local clock PLL to control the frequency of the local clock.

The divided recovered clock according to an embodiment may be generated by dividing the recovered clock by a real number corresponding to a number of symbols deserialized at a time from the deserialization register.

The control circuit may be further configured to control the local clock such that the frequency of the local clock is an integer multiple of the frequency of the divided recovered clock.

The control circuit according to an embodiment may be further configured to control the local clock such that the frequency of the local clock is greater than one times the frequency of the divided recovered clock and less than twice the frequency of the divided recovered clock.

The control circuit according to an embodiment may be further configured to detect a change in the frequency of the recovered clock, determine that the frequency of the divided recovered clock is higher than the frequency of the local clock based on a detection result, and adjust the frequency of the local clock to be higher based on a determination result.

The control circuit according to an embodiment may be further configured to detect a change in the frequency of the recovered clock based on an occupancy state of the elastic buffer.

The control circuit according to an embodiment may be further configured to detect at least one parameter associated with a factor for a change in the frequency of the recovered clock, predict, based on a detection result, that the frequency of the divided recovered clock is higher than the frequency of the local clock, and adjust, based on a prediction result, the frequency of the local clock to be higher.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram schematically illustrating a configuration of an electronic system according to an embodiment;

FIG. 2 is a block diagram showing an interface controller according to an embodiment;

FIG. 3A is a block diagram of an interface controller according to an embodiment; FIG. 3B is a diagram for describing an operation of an elastic buffer of FIG. 3A;

FIG. 4 is a diagram for describing an example of an elastic buffer according to an embodiment;

FIG. 5 is a flowchart for describing an operating method of a first device and a second device according to an embodiment;

FIG. 6 is a flowchart for describing an operating method of a first device and a second device according to an embodiment;

FIG. 7 is a flowchart for describing an operating method of a device according to an embodiment;

FIGS. 8A and 8B are diagrams for describing a control circuit implemented to perform an operation according to FIG. 7; and

FIG. 9 is a flowchart for describing an operating method of a device according to an embodiment.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term "and/or" includes any and all combinations of one or more of the associated listed items. Expressions such as "at least one of," when preceding a list of elements, modify the entire list of elements and do not modify the individual elements of the list.

Hereinafter, embodiments will be described in detail with reference to the accompanying drawings.

The embodiments are provided to more completely describe the disclosure to those of average knowledge in the art. The disclosure may have various changes thereto and various embodiments, and thus particular embodiments will be illustrated in the drawings and described in detail. It should be understood, however, that this is not intended to limit the disclosure to a particular embodiment, and should be understood to include all changes, equivalents, and alternatives falling within the spirit and scope of the disclosure. In describing each drawing, similar reference numerals are used for similar components. In the attached drawings, dimensions of structures are shown enlarged or reduced from actual ones to ensure clarity of the disclosure.

The term used herein is used to describe particular embodiments, and is not intended to limit the disclosure. Singular forms include plural forms unless apparently indicated otherwise contextually. Herein, it should be understood that the term "include", "have", or the like used herein is to indicate the presence of features, numbers, steps, operations, components, parts, or a combination thereof described in the specifications, and does not preclude the presence or addition of one or more other features, numbers, steps, operations, components, parts, or a combination thereof.

The terms, first, second, etc., may be used to describe various components, but the components are not limited by these terms. These terms are used to distinguish one component from another component. For example, a first component may be referred to as a second component without departing from the scope of the disclosure, and similarly, the second component may be referred to as the first component.

All of the terms used herein including technical or scientific terms have the same meanings as those generally understood by those of ordinary skill in the art of the disclosure, unless they are defined other. The terms defined in a generally used dictionary should be interpreted as having the same meanings as the contextual meanings of the relevant technology and should not be interpreted as having ideal or exaggerated meanings unless they are clearly defined in the present application.

In the following drawings and descriptions, a component shown or described as a block may be a hardware block or a software block. For example, each component may be an independent hardware block that signals to and from each other, or a software block that runs on a processor.

Hereinafter, embodiments will be described in detail with reference to the accompanying drawings.

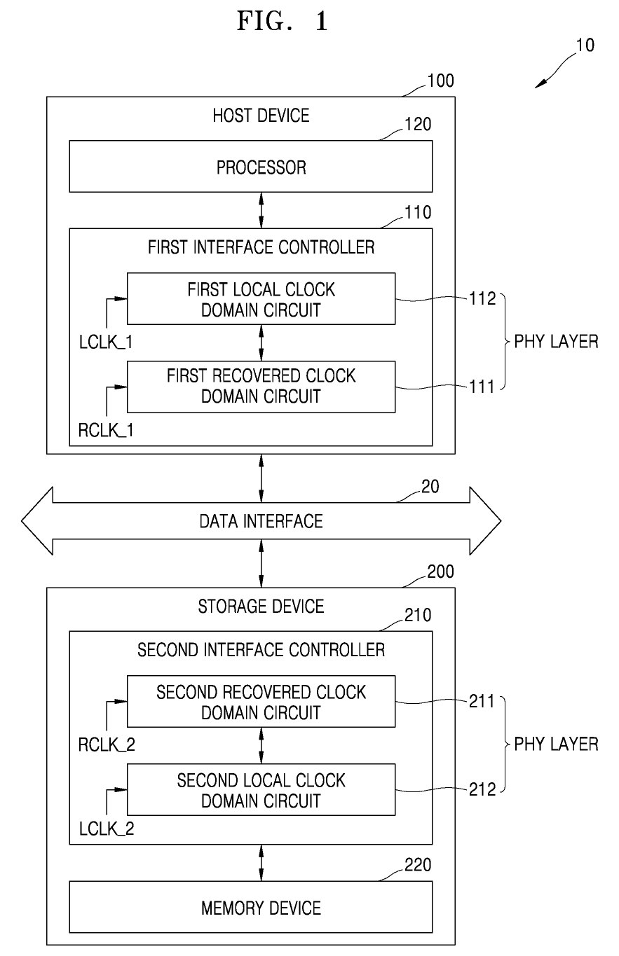

FIG. 1 is a block diagram schematically illustrating a configuration of an electronic system 10 according to an embodiment.

Referring to FIG. 1, the electronic system 10 may include a data interface 20, a host device 100, and a storage device 200. In an embodiment, the data interface 20 may be a high-speed serial interface. For example, the data interface 20 may be any one of a compute express link (CXL) interface, a peripheral component interconnect express (PCIe) interface, a serial AT attachment (SATA) interface, a universal serial bus (USB) interface, a display port interface, and an Ethernet interface.

The data interface 20 may be referred to as a high-speed serial interface, an interface bus, an interface, etc. The technical ideas of the disclosure may be based on the specifications outlined in the PCIe standard or the specifications defined in the CXL standard. However, these are merely embodiments, and without being limited thereto,

the technical ideas of the disclosure may also be applied to next-generation technologies for high-speed serial interfaces. The host device 100 and the storage device 200 may be referred to as devices, PCIe devices, CXL devices, etc. It will be appreciated that examples of the host device 100 and storage device 200 included in the electronic system 10 are merely illustrative for describing the technical ideas of the disclosure, and the technical ideas of the disclosure are not limited thereto.

In an embodiment, the host device 100 may be a host that provides data communication via the data interface 20. For example, the host device 100 may be a computing device or a motherboard thereof. For example, the computing device may be a personal computer (PC), a laptop computer, a mobile computing device, etc. In an embodiment, the storage device 200 may be connected to the host device 100 via the data interface 20 and may perform high-speed data communication with the host device 100 via the data interface 20.

Data transmitted and received via the data interface 20 between the host device 100 and the storage device 200 may include packets that may include symbols.

In an embodiment, the host device 100 may include a first interface controller 110 and a processor 120. For example, the first interface controller 110 may decode data received from the storage device 200 via the data interface 20 in a selected manner and provide the decoded data to the processor 120. The processor 120 may process the provided data. The first interface controller 110 may encode the data provided from the processor 120 in a selected manner and transmit the encoded data to the storage device 200 via the data interface 20.

In an embodiment, the first interface controller 110 may include a first recovered clock domain circuit 111 and a first local clock domain circuit 112. The first recovered clock domain circuit 111 and the first local clock domain circuit 112 may be included in a physical layer PHY LAYER. The physical layer PHY LAYER may be a layer containing all circuits required for high-speed serial communication using the data interface 20, and may include drivers, input buffers, serialization (or parallel-to-serial conversion) circuits, deserialization (or serial-to-parallel conversion) circuits, phase locked loop (PLL) and impedance matching circuits, etc. The physical layer PHY LAYER may support logical functions related to interface initialization and maintenance. The first interface controller 110 may further include a data link layer and a transaction layer for high-speed serial communication using the data interface 20, and a detailed description thereof will be omitted.

In an embodiment, the first recovered clock domain circuit 111 may be directly coupled to the data interface 20 and may operate based on a first recovered clock RCLK_1. In some embodiments, the clock may be referred to as a clock signal. The first recovered clock RCLK_1 may be a recovered clock based on a selected bit stream (or bit sequence) received via the data interface 20, which may correspond to a data transmission rate of the data interface 20. The first recovered clock RCLK_1 may be controlled via signaling over the data interface 20 between the first interface controller 110 and a second interface controller 210 that will be described later. Accordingly, the first recovered clock RCLK_1 and a second recovered clock RCLK_2 may be the same as or similar to each other. In an example, the first recovered clock domain circuit 111 may serialize data provided from the first local clock domain circuit 112 based on the first recovered clock RCLK_1, or deserialize data received via the data interface 20.

In an embodiment, the first local clock domain circuit 112 may operate based on a first local clock LCLK_1 having a frequency adaptively controlled based on the frequency of the first recovered clock RCLK_1. The first local clock LCLK_1 may be a clock generated by a local PLL within the first local clock domain circuit 112 (or the first interface controller 110), and may be a clock independently controlled by the first interface controller 110.

In an embodiment, the first interface controller 110 may control the frequency of the first local clock LCLK_1 adaptively to the frequency of the first recovered clock RCLK_1. In a specific example, the first interface controller 110 may control the first local clock LCLK_1 such that the frequency of the first local clock LCLK_1 used to output symbols from the elastic buffer included in the first recovered clock domain circuit 111 is higher than the frequency of the divided first recovered clock used to input symbols into the elastic buffer. In an example, the elastic buffer may be a first-in, first-out based buffer. In an example, the divided first recovered clock may be generated by dividing the first recovered clock RCLK_1 by a selected real number. In an example, the frequency of the first local clock LCLK_1 may be controlled to be an integer multiple of the frequency of the divided first recovered clock. In another example, the frequency of the first local clock LCLK_1 may be controlled to be greater than one times the frequency of the divided first recovered clock and less than twice the frequency of the divided first recovered clock. However, this is merely an embodiment, and the frequency of the first local clock LCLK_1 may be controlled in a variety of ways, without being limited thereto.

The first interface controller 110 may control the first local clock LCLK_1 under the following circumstances.

In a first embodiment, the first interface controller 110 may, in an initial setup period, set the frequency of the first local clock LCLK_1 based on a data transmission rate determined in response to the data transmission rate of the data interface 20 being determined by signaling with the second interface controller 210 via the data interface 20. In the disclosure, the initial setup period may be a period initialized during which the electronic system 10 is transitioned from a power-off state to a power-on state or during which the storage device 200 is newly connected to the host device 100. As a specific example, the first interface controller 110 may control the first local clock LCLK_1 such that the frequency of the first local clock LCLK_1 is higher than the frequency of the divided first recovered clock derived from the first recovered clock RCLK_1 corresponding to the determined data transmission rate.

In a second embodiment, the first interface controller 110 may, in a communication period, set the frequency of the first local clock LCLK_1 based on a data transmission rate changed in response to the data transmission rate of the data interface 20 being changed by signaling with the second interface controller 210 via the data interface 20. Herein, the communication period may be an interval in which the host device 100 and the storage device 200 communicate via the data interface 20. In an example, the first interface controller 110 may initiate a procedure for changing the data transmission rate of the data interface 20 in case that communication performance (e.g., a data error rate) between the host device 100 and the storage device 200 is less than a first threshold value or greater than a second threshold value. The first interface controller 110 may change the data transmission rate of the data interface 20 by signaling with the second interface controller 210 based on the initiated procedure. As a specific example, the first interface controller 110 may control the first local clock LCLK_1 such that the frequency of the first local clock LCLK_1 is higher than the frequency of the divided first recovered clock derived from the first recovered clock RCLK_1 corresponding to the changed data transmission rate.

In a third embodiment, the first interface controller 110 may detect a change in the frequency of the first recovered clock RCLK_1 in the communication period, and adjust the frequency of the first local clock LCLK_1 based on a result of the detection. For example, the frequency of the first recovered clock RCLK_1 may vary due to various factors in the host device 100 or the data interface 20. As a specific example, the first interface controller 110 may adjust the frequency of the first local clock LCLK_1 by directly or indirectly detecting a change in the frequency of the first recovered clock RCLK_1. As another specific example, the first interface controller 110 may detect at least one parameter associated with a factor for the change in the frequency of the first recovered clock RCLK_1 and adjust the frequency of the first local clock LCLK_1 based on a result of the detection. For example, the at least one parameter may include at least one of: a first parameter associated with a transmission media delay of the data interface 20, a second parameter associated with crosstalk between lanes included in the data interface 20, a third parameter associated with electromagnetic interference within the host device 100, and a fourth parameter associated with a temperature of the host device 100. However, this is merely an embodiment, and more parameters may be defined to detect a change in the frequency of the first recovered clock RCLK_1. The first interface controller 110 may control the first local clock LCLK_1 such that the frequency of the first local clock LCLK_1 is higher than the frequency of the divided first recovered clock RCLK_1 derived from the frequency-changed first recovered clock RCLK_1.

Herein, an operation of controlling a frequency of a local clock may include setting, changing, and adjusting the frequency of the local clock.

In an embodiment, the storage device 200 may include a second interface controller 210 and a memory device 220. For example, the second interface controller 210 may decode data received from the host device 100 via the data interface 20 in a selected manner and provide the decoded data to the memory device 220. The memory device 220 may store the provided data. The second interface controller 210 may encode the data provided from the memory device 220 in a selected manner and transmit the encoded data to the host device 100 via the data interface 20.

In an embodiment, the second interface controller 210 may include a second recovered clock domain circuit 211 and a second local clock domain circuit 212. The operation of the second recovered clock domain circuit 211 and the operation of the second local clock domain circuit 212 may be similar to the operation of the first recovered clock domain circuit 111 and the operation of the first local clock domain circuit 112 described above, and thus redundant descriptions will be omitted. Thus, the second local clock domain circuit 212 may operate based on a second local clock LCLK_2 having a frequency adaptively controlled based on the frequency of the second recovered clock RCLK_2. The second local clock LCLK_2 may be a clock generated by a local PLL within the second local clock domain circuit 212 (or the second interface controller 210), and may be a clock independently controlled by the second interface controller 210.

In an embodiment, the second interface controller 210 may control the frequency of the second local clock LCLK_2 adaptively to the frequency of the second recovered clock RCLK_2. In a specific example, the second interface controller 210 may control the second local clock LCLK_2 such that the frequency of the second local clock LCLK_2 used to output symbols from the elastic buffer included in the second recovered clock domain circuit 211 is higher than the frequency of the divided second recovered clock used to input symbols into the elastic buffer.

By the electronic system 10 according to an embodiment, the frequencies of the local clocks LCLK_1, LCLK_2 may be adaptively controlled based on the frequency of the recovered clocks RCLK_1, RCLK_2, thereby enabling efficient operation of the elastic buffer of the first recovered clock domain circuit 111 and the elastic buffer of the second recovered clock domain circuit 211, and minimizing the size of the elastic buffer to reduce the required design area.

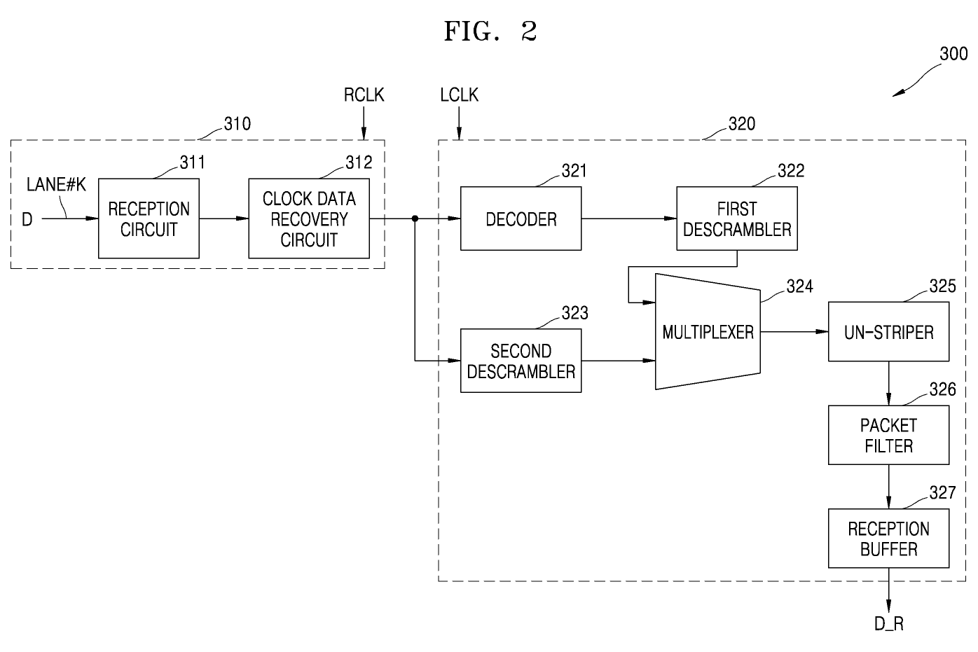

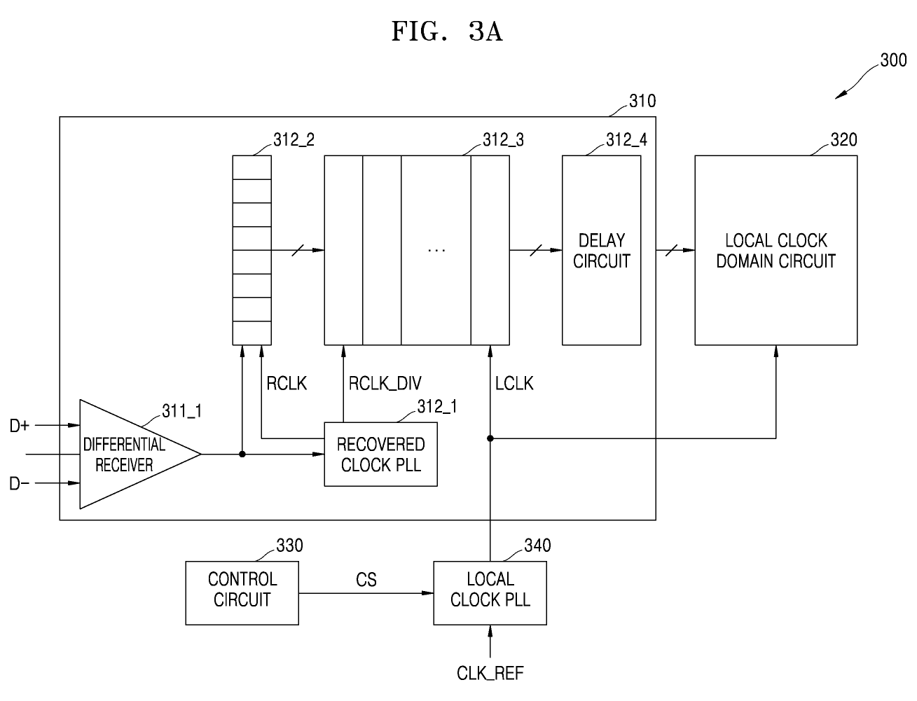

FIG. 2 is a block diagram showing an interface controller 300 according to an embodiment. The interface controller 300 may correspond to the first interface controller 110 or the second interface controller 210 of FIG. 1. It should also be appreciated that in FIG. 2, a partial configuration of the interface controller 300 based on a device for receiving data via the data interface is shown.

Referring to FIG. 2, the interface controller 300 may include a recovered clock domain circuit 310 and a local clock domain circuit 320. In an embodiment, the recovered clock domain circuit 310 may include a reception circuit 311 and a clock data recovery circuit 312. The local clock domain circuit 320 may include a decoder 321, a first descrambler 322, a second descrambler 323, a multiplexer 324, an un-striper 325, a packet filter 326, and a reception buffer 327.

In an embodiment, the reception circuit 311 may be connected to a Kth (where K is an integer of at least 1) lane LANE#K to receive data D over the lane LANE#K. The reception circuit 311 may provide the received data D to the clock data recovery circuit 312.

The clock and data recovery circuit 312 may perform operations based on a recovered clock RCLK. As a specific example, the clock data recovery circuit 312 may generate the recovered clock RCLK based on a selected bit stream received via the reception circuit 311, and deserialize the data D based on the recovered clock RCLK. The clock data recovery circuit 312 may then store the deserialized data in an elastic buffer based on the divided recovered clock generated by being divided by a selected real number from the recovered clock RCLK. For example, a selected integer may correspond to the number of symbols deserialized at a time. The elastic buffer may output the stored data to the local clock domain circuit 320 based on a local clock LCLK. In an embodiment, the interface controller 300 may control the local clock LCLK such that the frequency of the local clock LCLK is higher than the frequency of the divided recovered clock.

In an embodiment, the decoder 321, the first descrambler 322, the second descrambler 323, the multiplexer 324, the un-striper 325, the packet filter 326, and the reception buffer 327 may operate based on the local clock LCLK. In some embodiments, different phases of the local clock LCLK may be applied to at least two of the decoder 321, the first descrambler 322, the second descrambler 323, the multiplexer 324, the un-striper 325, the packet filter 326, and the reception buffer 327. The decoder 321 may decode the data output from the clock data recovery circuit 312, and the first descrambler 322 may descramble the decoded data and provide the same to the multiplexer 324. The second descrambler 323 may descramble the data output from the clock data recovery circuit 312 and provide the same to the multiplexer 324.

The multiplexer 324 may provide any one of the two received descrambled data to the un-striper 325. The un-striper 325 may un-strip the provided data and provide the same to the packet filter 326 that may filter the un-stripped data in a selected manner and provide the same to the reception buffer 327. The reception buffer 327 may output the stored data to a higher layer (e.g., a data link layer) as recovered data D_R.

An example of the local clock domain circuit 320 of FIG. 2 is merely an example, and without being limited thereto, the local clock domain circuit 320 may be implemented in a variety of ways depending on a decoding scheme supported by the high-speed serial interface.

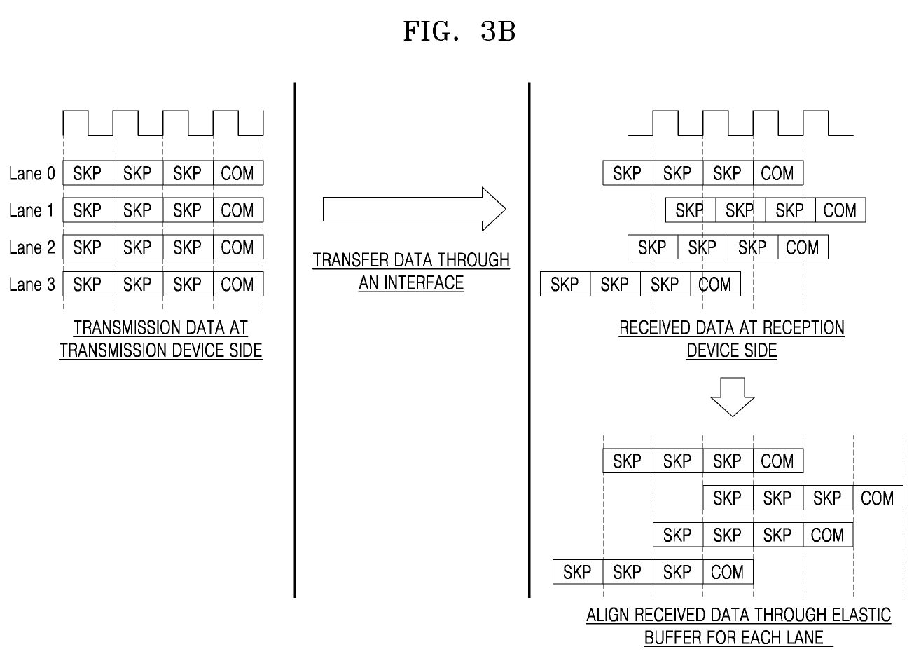

FIG. 3A is a block diagram of the interface controller 300 according to an embodiment, and FIG. 3B is a diagram for describing an operation of an elastic buffer 312_3 of FIG. 3A.

Referring to FIG. 3A, the interface controller 300 may include the recovered clock domain circuit 310, the local clock domain circuit 320, a control circuit 330, and a local clock PLL 340. In an embodiment, the recovered clock domain circuit 310 may include a differential receiver 311_1, a recovered clock PLL 312_1, a deserialization register 312_2, an elastic buffer 312_3, and a delay circuit 312_4. The differential receiver 311_1 may be an example of the reception circuit 311 of FIG. 2, and in some embodiments, the configuration of the delay circuit 312_4 may be omitted from the recovered clock domain circuit 310.

In an embodiment, the differential receiver 311_1 may receive positive data D+ and negative data D- via the Kth lane LANE#K (FIG. 2). In an example, the differential receiver 311_1 may be implemented as a differential amplifier. The recovered clock PLL 312_1 may generate the recovered clock RCLK based on a selected bit stream previously received from the differential receiver 311_1. The recovered clock PLL 312_1 may provide the recovered clock RCLK to the deserialization register 312_2 and may generate a divided recovered clock RCLK_DIV by dividing the recovered clock RCLK by a real number (e.g., 8.125) corresponding to eight, which is the number of symbols stored in the deserialization register 312_2. The recovered clock PLL 312_1 may provide the divided recovered clock RCLK_DIV to the elastic buffer 312_3. The deserialization register 312_2 may deserialize the data, output from the differential receiver 311_1 based on the recovered block RCLK, in 8 symbol units, through a sequence of operations of storing the output data based on the recovered clock RCLK and outputting the data based on the divided recovered clock RCLK_DIV. The elastic buffer 312_3 may store the data deserialized by the deserialization register 312_2 based on the divided recovered clock RCLK_DIV. In an embodiment, the elastic buffer 312_3 may include a plurality of slots, each of which may store deserialized symbols at a time. The elastic buffer 312_3 may output the stored deserialized data to the delay circuit 312_4 based on the local clock LCLK. The delay circuit 312_4 may compensate for a delay in the Kth lane LANE#K to which the differential receiver 311_1 is connected, and then provide the data to the local clock domain circuit 320.

In an embodiment, the interface controller 300 may further include an enable control circuit. The enable control circuit may enable or disable at least one configuration of the local clock domain circuit 320 based on the state of the elastic buffer 312_3. As a specific example, the enable control circuit may disable at least one configuration of the local clock domain circuit 320 in response to the elastic buffer 312_3 being empty, and enable at least one configuration of the local clock domain circuit 320 in response to the elastic buffer 312_3 being filled.

In an embodiment, the control circuit 330 may control the frequency of the local clock LCLK by providing a control signal CS to the local clock PLL 340 based on the recovered clock RCLK or the divided recovered clock RCLK_DIV to control the frequency of the local clock LCLK. As a specific example, the control circuit 330 may control the local clock PLL 340 such that the frequency of the local clock LCLK is higher than the frequency of the divided recovered clock RCLK_DIV. The local clock PLL 340 may be provided with a reference clock CLK_REF, and the local clock PLL 340 may generate the local clock LCLK from the reference clock CLK_REF based on the control signal CS. The local clock LCLK may be provided to the elastic buffer 312_3 and the local clock domain circuit 320. The reference clock CLK_REF may be generated by a device including the interface controller 300, or may be provided from another device via a data interface.

In an embodiment, the elastic buffer 312_3 may output data at a higher rate than a rate at which the data is stored due to a frequency difference between the local clock LCLK and the divided recovered clock RCLK_DIV, thereby minimizing the number of slots forming the elastic buffer 312_3.

Referring further to FIG. 3B, transmission data at a transmission device side may be aligned to a recovered clock of the transmission device side for each lane Lane 0 to Lane 3 and transmitted to a reception device side through an interface. In an example, the transmission data may include 'COM' packets and 'SKP' packets. This is for illustrative purposes, and the technical ideas of the disclosure are not to be construed as being limited thereto.

At the reception device side, received data may not be aligned to the recovered clock at the reception device side, and the received data may be aligned to the local clock through the elastic buffer provided for each lane (Lane 0 to Lane 3).

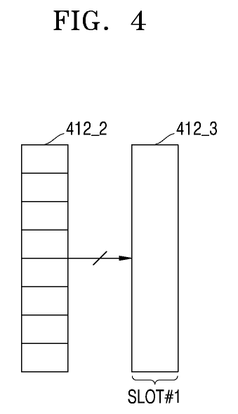

FIG. 4 is a diagram for describing an example of an elastic buffer 412_3 according to an embodiment.

Referring to FIG. 4, the elastic buffer 412_3 may include one slot SLOT#1. As a specific example, the elastic buffer 412_3 may include one slot SLOT#1 for storing deserialized data received at a time from the deserialization register 412_2. Accordingly, the storage capacity of the elastic buffer 412_3 may be the same or similar to the storage capacity of the deserialization register 412_2. In some embodiments, the elastic buffer 412_3 may be implemented to include a minimum number of additional slots to account for the possibility that the frequency of the divided recovered clock may change and reverse the frequency of the local clock under certain circumstances.

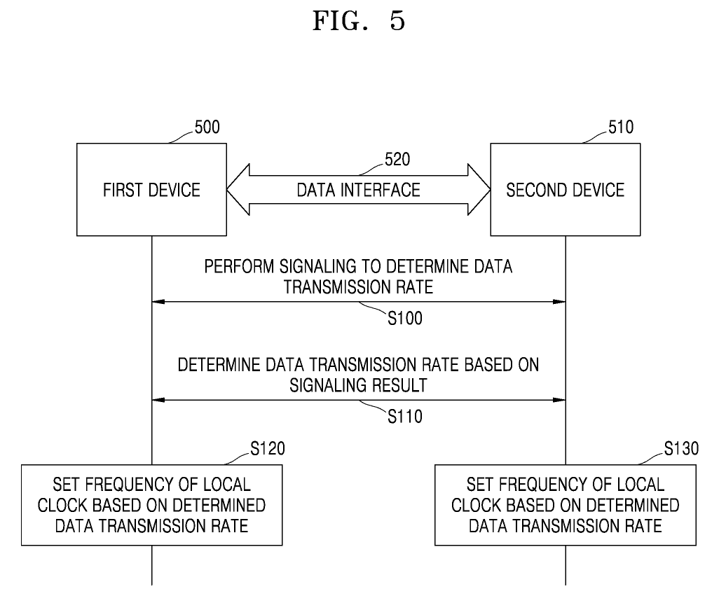

FIG. 5 is a flowchart for describing an operating method of a first device 500 and a second device 510 according to an embodiment. It is assumed that the first device 500 and the second device 510 of FIG. 5 communicate via a data interface 520 using an interface controller included in each.

Referring to FIG. 5, in operation S100, the first device 500 and the second device 510 may perform signaling to determine a data transmission rate via the data interface 520. Operation S100 may be an operation to determine values of configurations required for communication prior to performing full-scale communication via the data interface 520.

In operation S110, the first device 500 and the second device 510 may determine a data transmission rate of the data interface 520 based on a signaling result of operation S100.

In operation S120, the first device 500 may set the frequency of the local clock of the first device 500 based on the data transmission rate determined in operation S110. As a specific example, the first device 500 may generate a recovered clock based on the determined data transmission rate, and may set the local clock such that the frequency of the local clock is higher than the frequency of the recovered clock divided from the recovered clock.

In operation S130, the second device 510 may set the frequency of the local clock of the second device 510 based on the data transmission rate determined in operation S110. As a specific example, the second device 510 may generate a recovered clock based on the determined data transmission rate, and may set the local clock such that the frequency of the local clock is higher than the frequency of the recovered clock divided from the recovered clock.

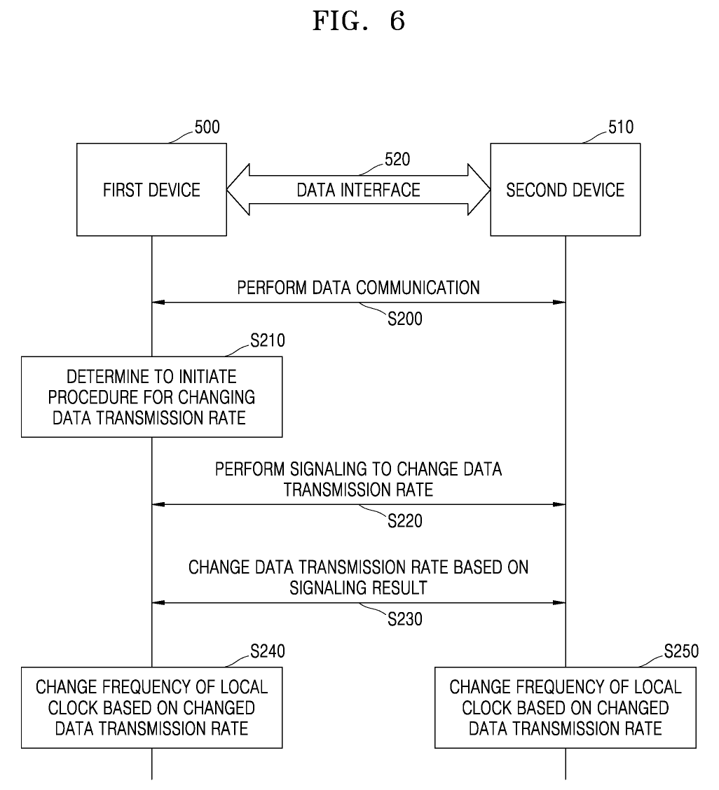

FIG. 6 is a flowchart for describing an operating method of the first device 500 and the second device 510 according to an embodiment. In FIG. 6, the first device 500 and the second device 510 communicate via the data interface 520 using the interface controller included in each based on the data transmission rate determined in FIG. 5.

Referring to FIG. 6, in operation S200, the first device 500 and the second device 510 may perform full-scale data communication via the data interface 520.

In operation S210, the first device 500 may determine to initiate a procedure to change the data transmission rate. As a specific example, the first device 500 may determine to initiate a procedure to increase the data transmission rate in case that performance in the data communication in operation S200 is good, and may determine to initiate a procedure to decrease the data transmission rate in case that the performance is poor. In this case, the first device 500 may correspond to a host device.

In operation S220, the first device 500 and the second device 510 may perform signaling to change the data transmission rate via the data interface 520. The signaling in operation S220 may be based on the procedure initiated in operation S210.

In operation S230, the first device 500 and the second device 510 may change the data transmission rate based on the signaling result of operation S220.

In operation S240, the first device 500 may change the frequency of the local clock of the first device 500 based on the data transmission rate changed in operation S230. As a specific example, the first device 500 may generate a recovered clock based on the changed data transmission rate, and may change the local clock such that the frequency of the local clock is higher than the frequency of the recovered clock divided from the recovered clock.

In operation S250, the second device 510 may change the frequency of the local clock of the second device 510 based on the data transmission rate changed in operation S230. As a specific example, the second device 510 may generate a recovered clock based on the changed data transmission rate, and may change the local clock such that the frequency of the local clock is higher than the frequency of the recovered clock divided from the recovered clock.

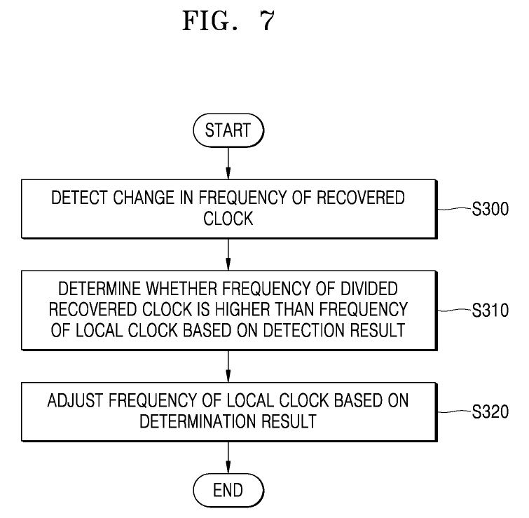

FIG. 7 is a flowchart for describing an operating method of a device according to an embodiment. The device of FIG. 7 may be the first device 500 or the second device 600 of FIG. 5. Further, the operation of the device of FIG. 7 may be understood as the operation of the control circuit described above.

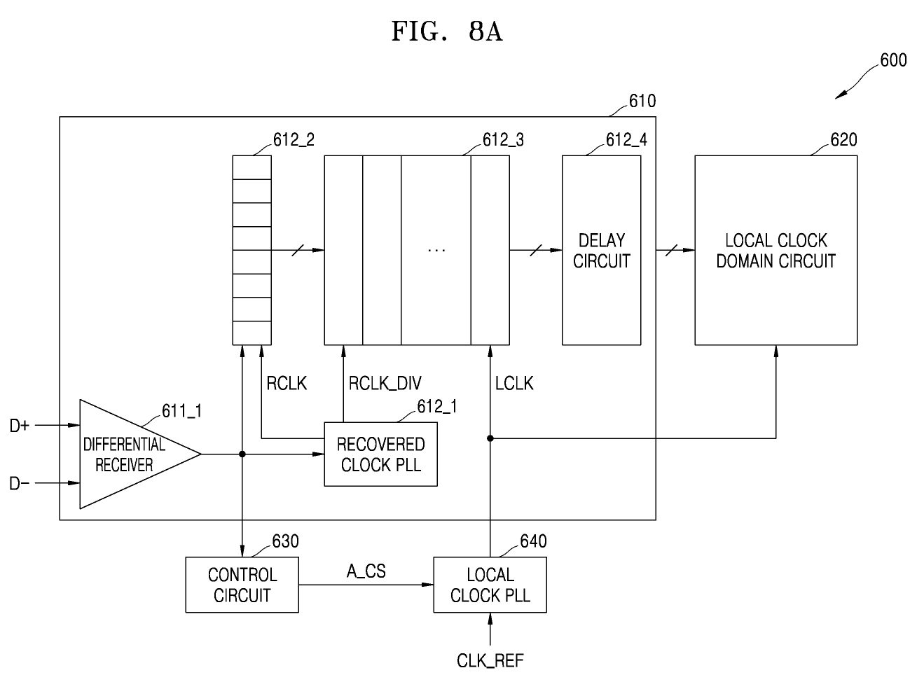

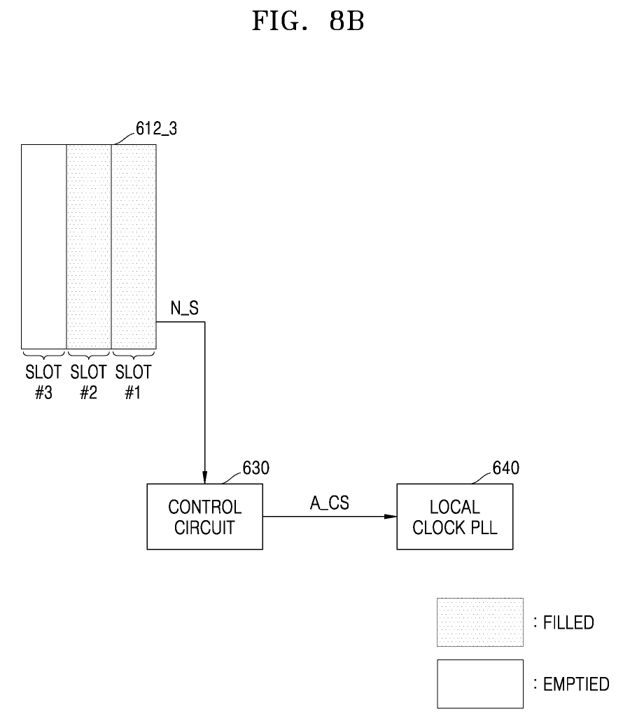

Referring to FIG. 7, in operation S300, the device may directly or indirectly detect a change in the frequency of the recovered clock. FIG. 8A shows an embodiment to directly detect a change in the frequency of the recovered clock, and FIG. 8B shows an embodiment to indirectly detect a change in the frequency of the recovered clock. The change in the frequency of the recovered clock may be caused by various factors in the device or in the data interface connected to the device.

In operation S310, the device may determine, based on the detection result of operation S300, whether the frequency of the divided recovered clock is higher than the frequency of the local clock.

In operation S320, the device may adjust the frequency of the local clock based on the determination result of operation S310. As a specific example, the device may adjust the local clock such that the frequency of the local clock is higher than the frequency of the divided recovered clock.

FIGS. 8A and 8B are diagrams for describing a control circuit 630 implemented to perform an operation according to FIG. 7. In FIG. 8A, redundancies with FIG. 3A will be omitted for convenience of description.

Referring to FIG. 8A, the control circuit 630 may directly detect a change in the frequency of the recovered clock RCLK by analyzing the data output from a differential receiver 611_1. The data may include a plurality of packets, each of which may include an identifier indicating a type of packet. As a specific example, the control circuit 630 may identify packets based on identifiers of the packets, recognize reception timings of the identified packets, and detect a change in the frequency of the recovered clock RCLK based on the recognized reception timings.

In an embodiment, the control circuit 630 may generate an adjustment control signal A_CS based on the detection result and provide the adjustment control signal A_CS to the local clock PLL 640 to adjust the frequency of the local clock LCLK.

Referring further to FIG. 8B, the elastic buffer 612_3 may include first to third slots SLOT#1, SLOT#2, and SLOT#3. The elastic buffer 612_3 may be subject to a change in the frequency of the recovered clock RCLK such that the frequency of the divided recovered clock may be higher than the frequency of the local clock, thereby causing the elastic buffer 612_3 to be filled faster than emptied. The elastic buffer 612_3 may provide a notification signal N_S to the control circuit 630 in response to the two slots SLOT#1 and SLOT#2 being filled.

In an embodiment, the control circuit 630 may indirectly detect a change in the frequency of the recovered clock RCLK based on the notification signal N_S, generate the adjustment control signal A_CS based on the detection result, and provide the adjustment control signal A_CS to the local clock PLL 640 to adjust the frequency of the local clock LCLK.

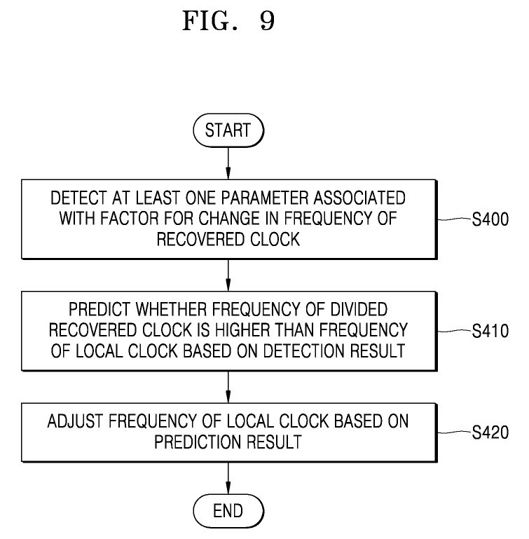

FIG. 9 is a flowchart for describing an operating method of a device according to an embodiment. The device of FIG. 9 may be the first device 500 or the second device 600 of FIG. 5. Further, the operation of the device of FIG. 9 may be understood as the operation of the control circuit described above.

Referring to FIG. 9, in operation S400, the device may detect at least one parameter associated with a factor for a change in the frequency of the recovered clock. As a specific example, the at least one parameter may include at least one of: a first parameter associated with a transmission media delay of a data interface connected to the device, a second parameter associated with a crosstalk between lanes of the data interface connected to the device, a third parameter associated with electromagnetic interference within the device, and a fourth parameter associated with a temperature of the device.

In operation S410, the device may predict, based on the detection result of operation S400, whether the frequency of the divided recovered clock is higher than the frequency of the local clock. The device may use a pre-trained neural network model for the prediction of operation S410. By feeding the detection result into the neural network model, it may be inferred whether the frequency of the divided recovered clock is higher than the frequency of the local clock based on a result output from the neural network model.

In operation S420, the device may adjust the frequency of the local clock based on the prediction result of operation S410. As a specific example, the device may adjust the local clock such that the frequency of the local clock is higher than the frequency of the divided recovered clock.

As above, embodiments have been disclosed in the drawings and specifications. Although the embodiments have been described using specific terms herein, they are merely used for the purpose of explaining the technical idea of the inventive concept, and are not used to limit the scope of the inventive concept described in the claims. It would be fully understood by those of ordinary skill in the art that various modifications and other equivalent embodiments are possible from the embodiments. Accordingly, the true technical scope of the disclosure should be defined by the technical spirit of the appended claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A first device communicating with a second device through a high-speed serial interface, the first device comprising:
an interface controller configured to recover data received via the high-speed serial interface; and
a component configured to perform a selected operation based on the recovered data,
wherein the interface controller comprises:
a recovered clock domain circuit configured to operate based on a recovered clock corresponding to a data transmission rate of the high-speed serial interface; and
a local clock domain circuit configured to operate based on a local clock having a frequency adaptively controlled based on frequency of the recovered clock.

2. The first device of claim 1, wherein the high-speed serial interface is implemented as any one of a compute express link (CXL) interface, a peripheral component interconnect express (PCIe) interface, a serial AT attachment (SATA) interface, a universal serial bus (USB) interface, a display port interface, and an Ethernet interface.

3. The first device of claim 1, wherein the recovered clock domain circuit comprises:
a deserialization register configured to deserialize the received data based on the recovered clock; and
an elastic buffer configured to store the deserialized data from the deserialization register based on a divided recovered clock, and to output the stored data to the local clock domain circuit based on the local clock,
wherein a frequency of the local clock is higher than a frequency of the divided recovered clock.

4. The first device of claim 3, wherein the elastic buffer comprises one slot for storing deserialized data received at a time from the deserialization register.

5. The first device of claim 3, wherein the local clock domain circuit comprises a decoder configured to decode data output from the elastic buffer based on the local clock.

6. The first device of claim 1, wherein the recovered clock domain circuit and the local clock domain circuit correspond to a physical layer.

7. The first device of claim 1, wherein the interface controller is further configured to, in an initialization period, signal with the second device via the high-speed serial interface to determine the data transmission rate of the high-speed serial interface and set a frequency of the local clock based on the determined data transmission rate.

8. The first device of claim 7, wherein the interface controller is further configured to, in a communication period, signal with the second device via the high-speed serial interface to change the data transmission rate of the high-speed serial interface and change a frequency of the local clock based on the changed data transmission rate.

9. The first device of claim 7, wherein the interface controller is further configured to, in the communication period, detect a change in the frequency of the recovered clock and adjust the frequency of the local clock based on a detection result.

10. The first device of claim 7, wherein the interface controller is further configured to, in the communication period, detect at least one parameter associated with a factor for a change in the frequency of the recovered clock and adjust the frequency of the local clock based on a detection result.

11. The first device of claim 10, wherein the at least one parameter comprises at least one of a first parameter associated with a transmission media delay of the high-speed serial interface, a second parameter associated with crosstalk between lanes of the high-speed serial interface, a third parameter associated with electromagnetic interference within the first device, and a fourth parameter associated with a temperature of the first device.

12. The first device of claim 1, wherein the component is implemented as a processor when the first device is implemented as a host device, and is implemented as a memory device when the first device is implemented as a storage device.

13. A first device communicating with a second device through a high-speed serial interface, the first device comprising:
an interface controller configured to recover data received via the high-speed serial interface; and
a component configured to perform a selected operation based on the recovered data,
wherein the interface controller comprises:
a deserialization register configured to deserialize the received data based on a recovered clock corresponding to a data transmission rate of the high-speed serial interface;
an elastic buffer configured to store deserialized data from the deserialization register based on a divided recovered clock and to output the stored data based on a local clock;
a decoder configured to decode data output from the elastic buffer based on the local clock; and
a control circuit configured to control the local clock such that a frequency of the local clock is higher than a frequency of the divided recovered clock.

14. The first device of claim 13, wherein the interface controller comprises:
a recovered clock phased locked loop (PLL) configured to generate the recovered clock; and
a local clock PLL configured to generate the local clock,
wherein control circuit is further configured to provide a control signal to the local clock PLL to control the frequency of the local clock.

15. The first device of claim 13, wherein the divided recovered clock is generated by dividing the recovered clock by a real number corresponding to a number of symbols deserialized at a time from the deserialization register.

16. The first device of claim 13, wherein the control circuit is further configured to control the local clock such that the frequency of the local clock is an integer multiple of the frequency of the divided recovered clock.

17. The first device of claim 13, wherein the control circuit is further configured to control the local clock such that the frequency of the local clock is greater than one times the frequency of the divided recovered clock and less than twice the frequency of the divided recovered clock.

18. The first device of claim 13, wherein the control circuit is further configured to detect a change in the frequency of the recovered clock, determine that the frequency of the divided recovered clock is higher than the frequency of the local clock based on a detection result, and adjust the frequency of the local clock to be higher based on a determination result.

19. The first device of claim 18, wherein the control circuit is further configured to detect a change in the frequency of the recovered clock based on an occupancystate of the elastic buffer.

20. The first device of claim 13, wherein the control circuit is further configured to detect at least one parameter associated with a factor for a change in the frequency of the recovered clock, predict, based on a detection result, that the frequency of the divided recovered clock is higher than the frequency of the local clock, and adjust, based on a prediction result, the frequency of the local clock to be higher.
